(19) United States
(12) Patent Application Publication
(10) Pub. No.: US 2005/0211653 A1
(43) Pub. Date: Sep. 29, 2005

(54) Mobile crane with stationary counterweight

(76) Inventor: Hans-Peter Franzen, Walshausen (DE)

Correspondence Address: Howard M. Ellis, Esq.;Simpson & Simpson, PLLC, 5555 Main Street, Williamsville, NY, 14221, US

(21) Appl. No.: 11/083,132

(22) Filed: Mar. 17, 2005

Related U.S. Application Data
(60) Provisional application No. 60/555,856, filed on Mar. 24, 2004.

(51) Int. Cl. B66C 23/26

(52) U.S. Cl. 212/270

(57) ABSTRACT

The invention relates to a method of erecting or lowering a boom (4) of a mobile crane (1), comprising a crane carrier and, slewably arranged on said crane carrier (2), a superstructure (3), on which a boom (4) is luffably attached. With the erecting method according to the present invention the boom (4) is mounted on the superstructure (3) of the crane boom (1) in an essentially horizontal position. Then the boom (4) or the superstructure (3) is connected to a fixed foundation (21) which is anchored in the ground, and after this the boom (4) is erected to the desired luffed position while using the foundation (21) as a counterweight. For lowering the boom (4), the above steps basically have to be carried out in reversed order. The invention also relates to the use of a foundation (21) of a building under construction, such as a wind power station (20), and a mobile crane, in particular a lattice boom crane (1), suitable for carrying out the methods.

### CROSS REFERENCE TO RELATED APPLICATIONS

This application claims the benefit of U.S. Provisional Patent Application Ser. No. 60/555,856, filed on Mar. 24, 2004 which is expressly incorporated herein, in its entirety, by reference.

### FIELD OF THE INVENTION

The present invention relates to a method of erecting or lowering a boom of a mobile crane, in particular a lattice boom crane, comprising a crane carrier and, rotatable on the crane carrier, a superstructure on which the boom is attached to be luffed. The invention also relates to a fixed foundation of a building under construction—such as a wind power station—which is adapted to be connected in a suitable way to act as a counterweight for erecting a mobile crane. Finally the invention relates to a mobile crane having a luffing boom and a guying assembly connected to the boom.

### BACKGROUND OF THE INVENTION

Mobile cranes of the above type, and in particular lattice boom cranes are used to lift heavy loads, sometimes at very great heights. Frequently loads having a weight of several tons, in particular loads having a weight of between 50 and 200 tons or more, have to be lifted to heights of more than 100 to 150 meters. It is therefore often necessary to attach extremely long booms in an essentially horizontal position at the superstructure of the mobile crane. In other words, a boom is at first assembled on the ground and then erected to the desired luffing position of the boom. A boom or a boom combination can comprise, for example, a main boom consisting of a plurality of sections. One or more fly jibs can also be mounted on the main boom. Fly jibs can be of the rigid or luffing type.

Basically the erecting can be carried out in an extended configuration of the boom or boom combination or in a “flexed” configuration. In the former case the boom already has the shape necessary for the load lifting operation. In the latter case, the boom changes its shape during or after erection, i.e. the final shape of the boom for the load lifting operation is different from the one during the assembly of the boom on the ground. With respect to the erection of booms or boom combinations of cranes such as lattice boom cranes, reference is made to Becker Rudolf, Dipl.-Ing., Das groβe Buch der Fahrzeugkrane, Band I—Handbuch der Fahrzeugkrantechnik (The great book of mobile cranes, volume I—handbook of mobile crane technology), 2^{nd} edition, Griesheim, K M Verlags GmbH, 2001, ISBN 3-934518-00-1, pp. 87 to 98. In particular, by explicit reference to this piece of literature, the state of the art mentioned therein is incorporated herein by reference. The same also applies to the configurations of booms, boom systems or boom combinations of mobile cranes as mentioned in the reference. In the present case, mobile cranes comprise any type of lattice boom crane, such as crawler type cranes with lattice booms, as well as other mobile cranes.

When such long booms or boom combinations are erected, there are extremely high erecting moments irrespective of the erecting configuration chosen, as explained above. Such erecting moments require correspondingly high counterweights or ballast weights. For example, a crawler crane is known from SU 1024413 A having a prop being guyed by means of a separate weight block on the ground. Said weight block being put on the ground must separately be carried to the site of operation of the crawler crane. A similar ballast assembly having a separate counterweight is disclosed in DE 196 42 066 A1. Herein, a mobile large-scale crane is disclosed, which is equipped with an additional counterweight or a separate ballast carriage. For the sake of completeness, reference is made to DE 102 12 305 A1 which shows a device for tower erection, wherein the tower consists of precasted elements and wherein a so called walking mechanism for the erection comprises a device by means of which a hoisting rope can be wound and wound up via a hoist winge being mounted on the ground.

However, in the actual load lifting operation of a crane as described before, in particular with very steeply positioned boom systems, such as are regularly required for example when building wind power stations, such great counterweights may not be necessary. It is thus only for erecting a long boom that great counterweight loads or amounts of ballast often have to be transported sometimes in inaccessible terrain, while the actual load lifting operation would allow smaller counterweight loads.

It is well known that wind power stations in particular are erected in regions which may be very difficult to access. Because of the ever higher structures of wind power stations, it is in these usages in particular that great loads, such as the generator housing and the rotor blades have to be brought up to great heights during the building of such wind power stations. This results in the problem that simply for the erection of very long boom combinations on mobile cranes, sometimes in not easily accessible terrain, high transportation costs arise due to the necessary amounts of ballast.

### SUMMARY OF THE INVENTION

According to a first aspect of the present invention, a method of erecting a crane boom is suggested. A boom of a mobile crane, comprising a crane carrier and, arranged on the crane carrier, a slewable superstructure, on which the boom is pivotably arranged, which is mounted on the superstructure in an essentially horizontal position. Then the boom or the superstructure is connected to a fixed foundation. With the help of the fixed foundation as a counterweight, the boom is eventually aligned in the desired luffing position.

In the variant of the method where there is a connection between the superstructure and the foundation, the superstructure has to be connected to the boom. With this method, a connection to the foundation as a counterweight is achieved via the superstructure.

The present invention is therefore based upon the idea of using an already present foundation of a building under construction as a counterweight for erecting a mobile crane. Depending on the boom combination chosen, the foundation alone can sometimes function as the counterweight, or perhaps the foundation is used in addition to the counterweights usually present on the crane. Thus, for example, the expensive transportation of sufficient counterweights necessary for erecting the crane but not necessary for the load lifting operation can be eliminated.

An exemplary embodiment of a method according to the present invention provides that the foundation and the boom or the superstructure are connected by means of a rope and/or a rod. The boom or the superstructure and the fixed foundation used as a counterweight can therefore be either connected only by means of ropes or rods used as guying elements. As an alternative, it is also possible to create combinations of ropes and rods to make the tensile connection for the erection process.

Another exemplary embodiment of the present invention provides that a derrick boom, also called a superlift, is present on the mobile crane, and the guying to the foundation is carried out via the derrick boom. For this purpose, at least one rope and/or at least one rod can be connected to the foundation and the derrick boom of the mobile crane. Then the derrick boom must be connected to the boom via at least one rope and/or rod. Alternatively, it can also be provided that the derrick boom is connected to a floating ballast, and the floating ballast in turn to the foundation.

An alternative exemplary embodiment of the present invention provides that no derrick boom, but only an erecting gantry is present on the mobile crane. With this exemplary embodiment of the present invention, a connection is made between the foundation and the erecting gantry or between the foundation and the superstructure via at least one rope and/or at least one rod.

The erecting gantry is also connected to the boom via at least one rope and/or rod. The superstructure is connected to the erecting gantry via at least one rope and/or rod.

Normally it can be expected that the connection between the foundation and the boom or the superstructure of the mobile crane is released once the boom has been erected so that the boom, now that it is in the predetermined operational position for lifting and lowering a load, can be slewed with the superstructure and/or can be displaced together with the carrier.

Alternatively, according to another exemplary embodiment of the invention, it is also possible to keep the connection between the boom and the foundation or between the superstructure and the foundation even during the lifting and lowering operation, for example when the crane as such does not have to be slewed or moved.

Another aspect of the present invention relates to a method of lowering a crane boom. For this purpose the order of the above process steps is basically reversed.

As can be seen from the above explanations with respect to the method according to the present invention, a part of the invention also comprises the special adaptation of a fixed foundation of a building under construction, such as a wind power station. According to another aspect of the present invention, a fixed foundation is equipped with a connection means, adapted for the connection of a guying means of a mobile crane so that this guying means establishes a connection between a boom of the mobile crane and the foundation. Thus for the first time a foundation is usable as a counterweight for the erection of a boom or a boom combination of a mobile crane.

For completeness, it should be noted that a boom combination can comprise a main boom and a fly jib mounted on it, sometimes having adapters for luffing etc. Therefore, boom combinations may consist in particular of a main boom and a needle jib mounted on it, a rigid fly jib or a luffing fly jib.

Let it be mentioned only by way of example that a connection means in the above sense can take any form whatsoever which allows a releasable rope or rod connection. For example, connection means are conceivable such as are frequently used in crane technology. A connection means can be, for example, in the form of a bolt connection so that a rope or a rod can be fastened in a ring of the foundation. The reverse form is also possible so that a connection element can be present at the rope or rod in the form of a ring and that only the rope can be bolted or the like in an eye or tab or the like of the foundation.

In another exemplary embodiment, a foundation adapted according to the present invention is a foundation of a wind power station, in particular a so-called flat bed foundation as is often used with wind power stations. The anchoring element of the connection element can be embedded in the concrete in any manner or otherwise secured in the foundation.

According to another aspect of the present invention, a mobile crane is provided with a luffing boom and with a guying assembly connected on the boom. A connection means is attached to the guying assembly which is configured in such a way that it can be connected to a fixed foundation of a building under construction used as a counterweight when the boom is erected from an essentially horizontal position. The same also applies when the boom is lowered to an essentially horizontal position. In other words, such a connection means can be releasably attached to the fixed foundation so that it is connected to the boom or the superstructure when the boom is erected or lowered and therefore acts as a counterweight.

As initially mentioned, according to another exemplary embodiment, a mobile crane can be equipped with a derrick boom which is connected to the boom. The derrick boom or the superstructure, in turn, must be coupled to the foundation via the guying means and the connection means. According to another modification of an exemplary embodiment of a mobile crane according to the present invention, the guying means can also include the connection between the boom and the derrick boom or between the boom and the superstructure.

An alternative exemplary embodiment provides that instead of a derrick boom, a gantry, known per se, is present. In this case the guying means is connected on the one hand to the gantry or the superstructure and on the other hand it has a connection means to attach the boom to the foundation as a counterweight during the erection process by means of a support via the gantry or the superstructure.

A mobile crane in the sense of the present invention is especially a lattice boom crane equipped either with a well-known carrier vehicle having wheels, or a crawler-type carrier.

### BRIEF DESCRIPTION OF THE DRAWINGS

For further description and further explanation a number of exemplary embodiments will be described in the following with reference to the accompanying drawings, in which:

FIG. 1a is a schematic elevational view of a lattice boom crane with a crawler-type carrier and a derrick boom next to a wind power station during the erection of the boom, wherein a connection is established between the derrick boom and the foundation of the wind power station;

FIG. 1b is a view, similar to that of FIG. 1a, of the lattice boom crane with a crawler-type carrier and a derrick boom after the erection process; and

FIG. 2 is a view, similar to that of FIG. 1, of another alternative lattice boom crane according to the present invention with a gantry instead of a derrick boom.

### DETAILED DESCRIPTION OF THE INVENTION

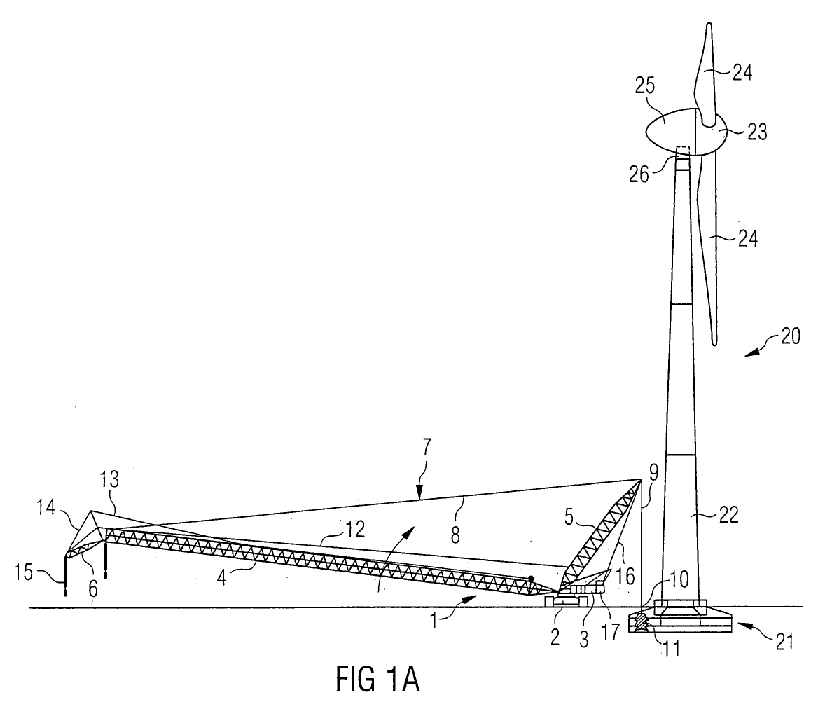

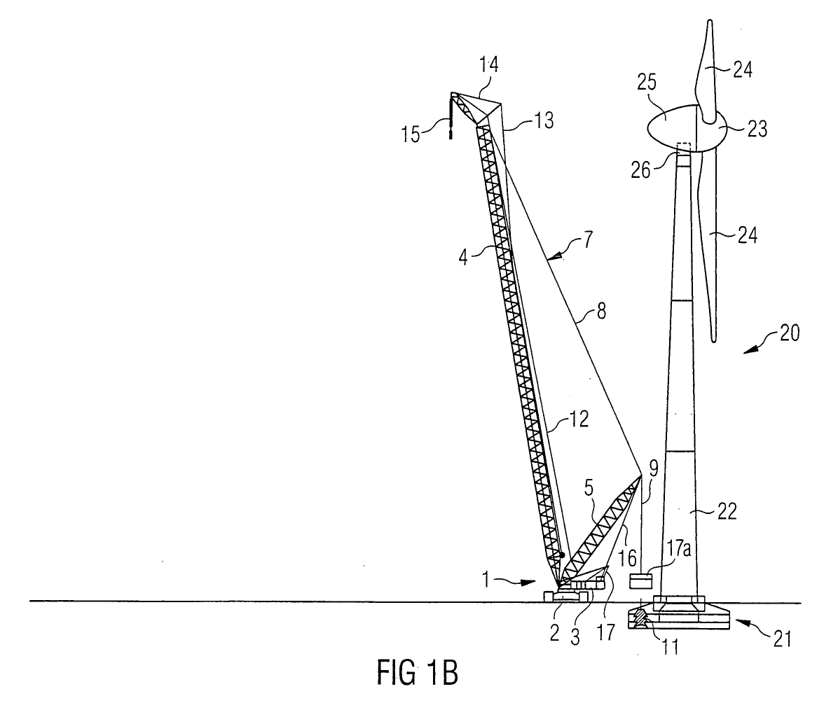

FIG. 1a shows a lattice boom crane 1 with a crawler-type carrier 2 and a superstructure 3 arranged on it, in an elevational view. A boom 4 is luffable on superstructure 3. Boom 4 consists of a plurality of lattice boom sections with a rigid fly jib 6 mounted at the top.

The lattice boom 1 shown here also has a derrick boom 5 which is connected, via a guying means 7, to a boom head of boom 4, to superstructure 3 and a foundation 21 of a wind power station 20. Guying means 7 comprises on the one hand a rope 8 which establishes a connection between the free end of derrick boom 5 and the head of boom 4. Moreover, the top end of derrick boom 5 is connected, via a rope 9 (which can also be a rod and/or a rope-rod combination) and via a connection means 10, to an anchoring means 11 in foundation 21 of wind power station 20. This will be described in more detail below. Derrick boom 5 is also connected to a counterweight 17 of mobile crane 1 via a rope 16.

Fly jib 6 is guyed on boom 4 in a fixed manner via lines 13, 14. A hoist line 12 runs via the top end of boom 4 and of fly jib 6 and ends in a tip sheave 15 from which a load hook may be suspended.

The wind power station 20 is fixedly anchored in the ground via foundation 21. Foundation 21 is a so-called flat bed foundation as often used for wind power stations.. The tower 22 of wind power station 20 consists of a plurality of segments which are placed one on top of the other by means of crane 1. At the top end of tower 22, a hub 25 with a generator, etc. is mounted so as to be rotatable by means of bearings 26. Hub 25 comprises a front hub portion 23 at which the rotor blades 24 extend. In particular, mobile cranes 1 of the above type are used to place hub 25 with blades 24 on the top of tower 22 of a wind power station.

In the configuration as shown in FIG. 1a, the boom, which was assembled on the ground in its full length, is brought into the desired operational position as indicated by the arrow. During the erection process, the rope connection 9 between derrick 5 and foundation 21 serves to balance out the resulting erection moment. This allows less counterweight 17 to be used than previously. It would also be possible to equip derrick 5 with a floating ballast 17a, as is basically shown in FIG. 1b, and then to connect floating ballast 17a to foundation 21, in order to erect or lower boom 4.

The configuration as shown in FIG. 1b now shows boom 4 in the actual load lifting operational position in which, for example, hub 25 of wind power station 20 or the individual segments of tower 22 can be placed on top of each other. As shown in FIG. 1b, the connection with foundation 21 via anchoring element 11 has now been released, and additional counterweights 17a are now suspended from the rope which established the connection before. Usually, a considerably greater amount of weight would be necessary in the form of a floating ballast 17a in order to balance out the erection moment. Therefore, a configuration would be conceivable in which for erecting boom 4 a counterweight of 510 t is necessary, when for the load case, only 200 t of counterweight are to be used. Usually therefore, an amount of counterweight of 310 t would have to be transported which corresponds to the payload of about ten trucks. These ten truck-loads are eliminated according to the present invention, since due to the use of foundation 21 as a counterweight, the amount of counterweight of 310 t need no longer be transported to the worksite of wind power station 20.

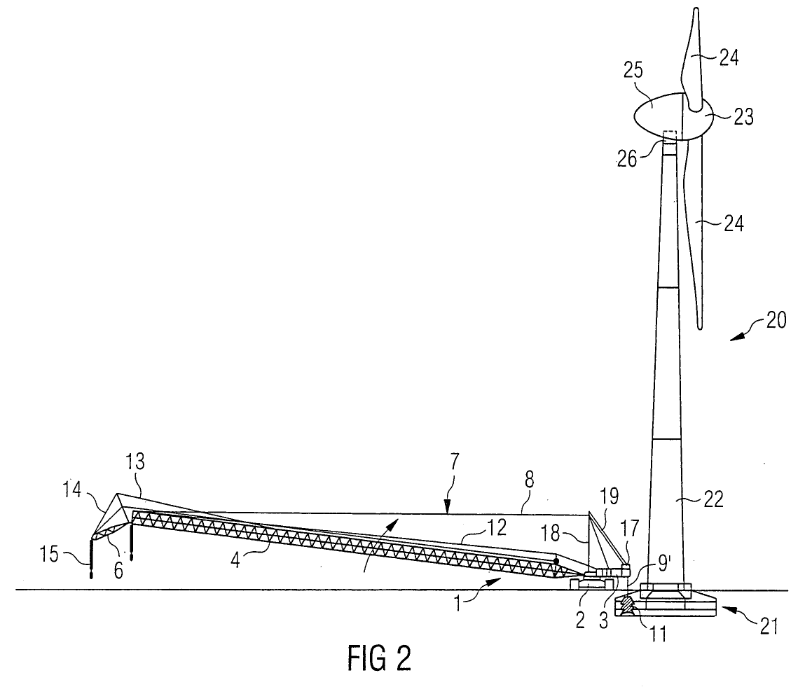

The embodiment as shown in FIG. 2 of the present invention shows a lattice boom crane with a crawler-type carrier 2, as in FIG. 1, but instead of a derrick boom 5, a gantry 18 is present, which is connected to a counterweight 17 via ropes 19. These ropes 19 or the counterweight, or the superstructure in any kind of way, are connected to foundation 21, as in the configuration shown in FIG. 1a, in order to create a balance when boom 4 is erected.

1. A method of erecting a boom of a mobile crane, comprising a crane carrier and, slewably arranged on said crane carrier, a superstructure, on which the boom is attached in a luffable manner, the method comprising the steps of:
mounting the boom on the superstructure of said mobile crane in an essentially horizontal position;
connecting the boom to a fixed foundation anchored in the ground; and
erecting the boom to the desired luffing position while using the foundation as a counterweight.

2. The method according to claim 1, wherein the foundation and the boom are connected to each other via at least a rope and/or a rod.

3. The method according to claim 1, wherein at least a rope and/or at least a rod is connected to the foundation and to a derrick boom of said mobile crane and wherein said derrick boom is connected to the boom via at least a rope and/or a rod.

4. The method according to claim 1, wherein at least a rope and/or at least a rod is connected to the foundation and to a gantry of said mobile crane and wherein said gantry is connected to the boom via at least a rope and/or a rod.

5. The method according to claim 1, wherein after erecting the boom the connection between the foundation and the boom is released.

6. A method of lowering a boom of a mobile crane, comprising a crane carrier and, slewably arranged on said crane carrier, a superstructure, on which the boom is attached in a luffable manner, the method comprising the steps of:
connecting the boom or the superstructure to a fixed foundation anchored in the ground; and
lowering the boom in an essentially horizontal position while using the foundation as a counterweight.

7. A fixed foundation of a building under construction, comprising a connection means adapted so as to be connected to a guying means of a mobile crane.

8. The foundation according to claim 7, wherein the connection means comprises an anchoring element embedded in the foundation and a connection element linked to the latter and accessible from the outside adapted to be releasably connected to said guying means.

9. The foundation according to claim 7, wherein said foundation is a foundation of a wind power station.

10. The foundation according to claim 9, wherein the foundation of a wind power station is a flat bed foundation.

11. A use of a foundation of a building under construction, as a counterweight during the erecting or lowering of a boom of a mobile crane.

12. The use according to claim 11, wherein said foundation is used as a counterweight during the erecting or lowering of a boom of a mobile crane in addition to a crane counterweight.

13. The use according to claim 11, wherein the mobile crane is a lattice boom crane.

14. A mobile crane, having:
a slewable superstructure;
a boom luffably arranged on the superstructure;
a guying means connected to the boom and/or the superstructure, and
a connection means, connected to the guying means and adapted so as to be connected to a fixed foundation of a building under construction as a counterweight while the boom is erected from or lowered to an essentially horizontal position.

15. The mobile crane according to claim 14, wherein said mobile crane comprises a derrick boom connected to the boom, and the guying means is connected to the derrick boom or to the superstructure at one end and has the connection means at the other end.

16. The mobile crane according to claim 14, wherein the mobile crane comprises a gantry connected to the boom, and the guying means is connected to the gantry or to the superstructure at the one end and has the connection means at the other end.

17. The mobile crane according to claim 14, wherein the mobile crane is a lattice boom crane.
